(19) United States
(12) Patent Application Publication
(10) Pub. No.: US 2007/0192015 A1
(43) Pub. Date: Aug. 16, 2007

(54) Engine torque estimating device

(75) Inventor: Yuji Konishi, Chiryu-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/653,849

(22) Filed: Jan. 17, 2007

(30) Foreign Application Priority Data
Feb. 13, 2006 (JP) 2006-34627

(51) Int. Cl. G06F 19/00; G01M 15/00; G01L 3/26

(52) U.S. Cl. 701/102; 73/117.3; 701/115

(57) ABSTRACT

A torque estimation error, which is an error between an estimated value and an actual value of the engine torque, is detected at first. Then, an error of a characteristic for engine frictional loss is learned based on the torque estimation error which is detected when ignition timing is around a most appropriate timing. An error of a characteristic for an ignition timing efficiency, which represents a relation between the ignition timing and an engine torque change, is further detected, based on the torque estimation error which is detected when ignition timing is delayed from the most appropriate timing. And the estimated value of the engine torque is corrected based on learning values for the errors of the engine frictional loss and the ignition timing efficiency.

### CROSS REFERENCE TO RELATED APPLICATION

This application is based on Japanese Patent Application No. 2006-34627, which is filed on Feb. 13, 2006, the disclosure of which is incorporated herein by reference.

### FIELD OF THE INVENTION

The present invention relates to an engine torque estimating device for estimating the engine torque.

### BACKGROUND OF THE INVENTION

In a recent electronic engine management system for a vehicle, an engine torque is controlled by adjusting an opening degree of a throttle valve. In such an engine management system, the engine torque demanded by a vehicle driver is calculated, for example, based on an operational stroke of an acceleration pedal by the vehicle driver, in order to achieve a drivability having a high response to the operation of the acceleration pedal. In the case that there is an error between an estimated value and an actual value for the engine torque, in the above engine torque control, the engine torque is not controlled at a correct value, causing deterioration of the drivability (such as, an insufficient acceleration, a shock in a gear change, and so on).

Therefore, a map for an engine torque characteristic is prepared in a step of an application work, and stored in a memory device (ROM) of an engine control unit (ECU), in order to suppress or minimize the possible error (an error in the torque estimation) between the estimated value and the actual value for the engine torque. Then, the engine torque is estimated by use of the map for the engine torque characteristic during an actual engine operation.

However, an actual engine torque characteristic varies across the ages. Accordingly, when the engine torque is estimated by use of the map for the engine torque characteristic, which is prepared in advance in the application work step, a possible error between the estimated value and the actual value will be increased as the time passes. An accuracy for the engine torque estimation is thus deteriorated.

According to a prior art, for example, U.S. Pat. No. 6,188,951 B1, a secular change of an engine frictional loss (a friction loss) is regarded as a parameter for a secular change of an engine torque characteristic. An error between a target idling speed and an actual idling speed is detected during the idling operation of the engine, the error is learned as information for the secular change of the engine frictional loss, and map data for the engine torque characteristic is corrected based on such learning values.

According to a recent investigation, however, it is made apparent, as shown in FIG. 3, that a secular change of a characteristic for ignition timing efficiency (a characteristic representing a relation between ignition timing and the engine torque change) should be also considered as a parameter for the secular change of the engine torque characteristic, in addition to the secular change of the engine frictional loss.

FIG. 3 shows the relation between the ignition timing and the engine torque change, wherein the engine torque is decreased as the ignition timing is delayed. At the step of the application work, since the secular change has not yet been generated, an error between an estimated value (an applied value) and an actual value of the engine torque may not occur, when variations among the individual products are not considered. When the engine torque characteristic is changed by the secular change, namely when the engine torque characteristic becomes different from that at the application work, the error (the torque estimation error) is generated between the estimated value (the applied value) and the actual value of the engine torque.

One of the parameters for the secular change of the engine torque characteristic is the secular change of the engine frictional loss, as explained above. The error in the engine frictional loss is not largely changed with respect to the change of the ignition timing. In other words, the error in the engine frictional loss is almost constant with respect to the change of the ignition timing.

The torque estimation error between the estimated value (the applied value) and the actual value of the engine torque becomes to a minimum value at such an ignition timing “MBT (Minimum spar advance for Best Torque)”, at which the engine torque as well as a fuel consumption ratio becomes at its best value. On the other hand, the torque estimation error becomes to a larger value, as a delayed amount of the ignition timing from the ignition timing of “MBT” is made larger.

According to the investigation of the inventor of the present invention, the torque estimation error at the ignition timing of “MBT” corresponds to the error of the engine frictional loss. This is because the error of the characteristic for the ignition timing efficiency becomes zero at “MBT”, as explained below. Since the error of the engine frictional loss to be caused by the secular change is not largely changed but rather constant, the torque estimation error caused by the other parameters than the engine frictional loss becomes larger, as the delayed amount of the ignition timing from the ignition timing of “MBT” is made larger.

The torque estimation error caused by the other parameters than the engine frictional loss is considered as to correspond to an error (also referred to as “an error of the characteristic for the ignition timing efficiency”) caused by a secular change of the characteristic representing the relation between the ignition timing and the engine torque change.

According to the prior art, for example as disclosed in the above U.S. Pat. No. 6,188,951 B1, the secular change of the engine torque characteristic is fully regarded as the secular change of the engine frictional loss. The torque estimation error detected at the ignition timing, which is largely delayed, is fully learned as the error of the engine frictional loss, even though the torque estimation error may include the error of the characteristic for the ignition timing efficiency. As a result, the accuracy for learning the secular change of the engine torque characteristic is deteriorated, and thereby the accuracy for estimating the engine torque is deteriorated.

### SUMMARY OF THE INVENTION

The present invention is made in view of the above problems. It is an object of the present invention to provide an engine torque estimating device, in which the accuracy for learning the secular change of the engine torque characteristic is improved.

According to a feature of the present invention, an engine torque estimating device has a first means for detecting a torque estimation error, which is an error between an estimated value and an actual value of the engine torque, a second means for learning an error of a characteristic for engine frictional loss, based on the torque estimation error which is detected when ignition timing is around a most appropriate timing, a third means for learning an error of a characteristic, which represents a relation between the ignition timing and an engine torque change, based on the torque estimation error which is detected when ignition timing is delayed from the most appropriate timing, and a fourth means for correcting the estimated value of the engine torque based on learning values obtained in the third means.

According to the above feature of the invention, the error of the characteristic for the ignition timing efficiency, which is generated when the ignition timing is delayed, can be learned as the torque estimation error, which is caused by the secular change of the engine torque characteristic, in addition to the error of the characteristic for the engine frictional loss. Accordingly, the torque estimation error (which is caused by the secular change of the engine torque characteristic) can be calculated and learned more accurately than the conventional method. In other words, the learning values for the torque estimation error can be corrected more accurately.

According to a further feature of the invention, the first means may detect a deviation of engine rotational speed between an actual engine rotational speed and a target idling rotational speed during an idling operation of the engine, and calculates the torque estimation error based on such deviation. This is because the deviation of engine rotational speed between the actual engine rotational speed and the target idling rotational speed becomes larger, as the torque estimation error is larger. It is desirable to detect the deviation of engine rotational speed between the actual engine rotational speed and the target idling rotational speed, before an ISC (Idle Speed Control) operation is started. This is because an intake air amount is controlled in a feedback manner, such that the deviation of the engine rotational speed between the actual engine rotational speed and the target idling rotational speed will become smaller, after the ISC operation.

According to another feature of the invention, the first means may detect a deviation of engine rotational speed between an actual engine rotational speed and an ideal idling rotational speed during a gear change operation, and calculates the torque estimation error based on such deviation. The ideal idling rotational speed at the gear change operation is already obtained in the process for the application work. Accordingly, the deviation of the engine rotational speed between the actual engine rotational speed and the ideal idling rotational speed at the gear change operation can be obtained as the information for the torque estimation error.

According to a still further feature of the invention, the error of the characteristic for the engine frictional loss is at first calculated and learned, and then the error of the characteristic for the ignition timing efficiency is calculated and learned.

The error of the characteristic for the ignition timing efficiency can be calculated and learned more accurately, by subtracting the learning value for the error of the characteristic for the engine frictional loss from the torque estimation error detected when the ignition timing is delayed from the most appropriate ignition timing. This is because the error of the characteristic for the engine frictional loss is almost constant with respect to the change of the ignition timing.

According to a still further feature of the invention, it is desirable to learn a changing rate of the engine torque as the error of the characteristic for the ignition timing efficiency. The changing rate of the engine torque is calculated from the engine torque when the ignition timing is around the most appropriate timing and the engine torque when the ignition timing is delayed from the most appropriate timing. According to the above feature, the error of the characteristic for the ignition timing efficiency can be learned in the same measuring unit to the map data for the ignition timing efficiency, which is generally used when correcting the demanded engine torque in accordance with the delayed amount of the ignition timing. As a result, the process for correcting the map data for the ignition timing efficiency can be carried out with a simpler calculation process (i.e. addition or subtraction) by using the learning values for the error of the characteristic for the ignition timing efficiency.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic view showing a structure of an engine control system according to an embodiment of the present invention;

FIG. 2A is a block diagram for explaining a function of an engine torque control;

FIGS. 2B to 2D are enlarged block diagrams of respective portions 2B to 2D shown in FIG. 2A;

FIG. 3 is a graph for explaining a secular change of the engine torque characteristic;

FIG. 4 is a flow chart showing a process for correcting the torque estimation error by learning values;

FIG. 5 is a graph showing a method of detecting a deviation “ΔNe” of an engine rotational speed at an idling operation of the engine;

FIG. 6 is a graph showing a method of detecting a deviation “ΔNe” of an engine rotational speed when a gear is shifted;

FIG. 7 is a map showing an example for calculating an error “ΔTrq” for the torque estimation with respect to the deviation “ΔNe” (=N2−N1) of the engine rotational speed;

FIG. 8 is a map showing an example for engine frictional loss; and

FIG. 9 is a map showing an example for efficiency of ignition timing.

### DETAILED DESCRIPTION OF THE PREFERRED EMBODIMENTS

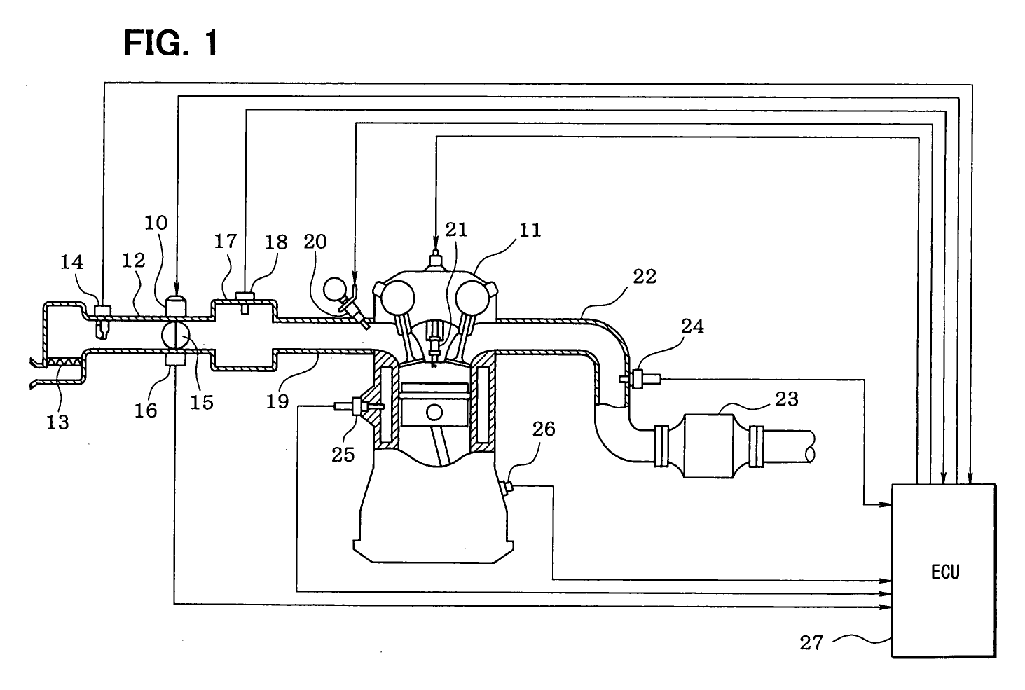

An embodiment of the present invention will be explained. A structure of an engine control system will be explained with reference to FIG. 1. An air cleaner 13 is provided at an upstream end of an air intake pipe 12 of an engine 11. An air-flow meter 14 is provided at a downstream side of the air cleaner 13, for detecting an amount of intake air to the engine 11. A throttle valve 15 and a throttle valve sensor 16 are provided at a downstream side of the air-flow meter 14, wherein an opening degree of the throttle valve 15 is controlled by an electric motor 10, and the sensor 16 detects the opening degree of the throttle valve 15.

A surge tank 17 is further provided at a downstream side of the throttle valve 15, and a pressure sensor 18 for detecting intake air pressure is provided at the surge tank 17. Multiple intake manifolds 19 are connected to the surge tank 17, for introducing the intake air into respective cylinders of the engine 11. A fuel injection valve 20 is provided adjacent to an intake port of the respective intake manifolds 19 for injecting fuel into the intake manifold. A spark plug 21 is mounted to a cylinder head of the engine 11 for the respective cylinders, so that air-fuel mixture in each of the cylinders is ignited by spark discharge at the spark plug 21.

A catalyst 23, such as a three way catalyst for purifying CO, HC, NOx and so on contained in exhaust gas, is provided in an exhaust gas pipe 22 of the engine 11. An exhaust gas sensor 24 (e.g. an air-fuel ratio sensor, an oxygen sensor, or the like) is provided at an upstream side of the catalyst 23 for detecting air-fuel ratio, a rich condition, or a lean condition of the exhaust gas.

A temperature sensor 25 is provided at a cylinder block cf the engine 11 for detecting temperature of engine cooling water. A crank angle sensor 26 is also provided at the cylinder block for outputting pulse signals for every angular rotation of a crank shaft of the engine 11 by a predetermined angle. The crank angle as well as engine rotational speed is detected based on the output signals from the crank angle sensor 26.

The output signals from the above sensors are inputted to an engine control unit (ECU) 27, which is composed of a micro-computer to perform engine control programs memorized in the memory device (ROM), so that the opening degree of the throttle valve 15, the amount of fuel injected by the fuel injection valve 20, the ignition timing for the spark plug 21 and so on are controlled.

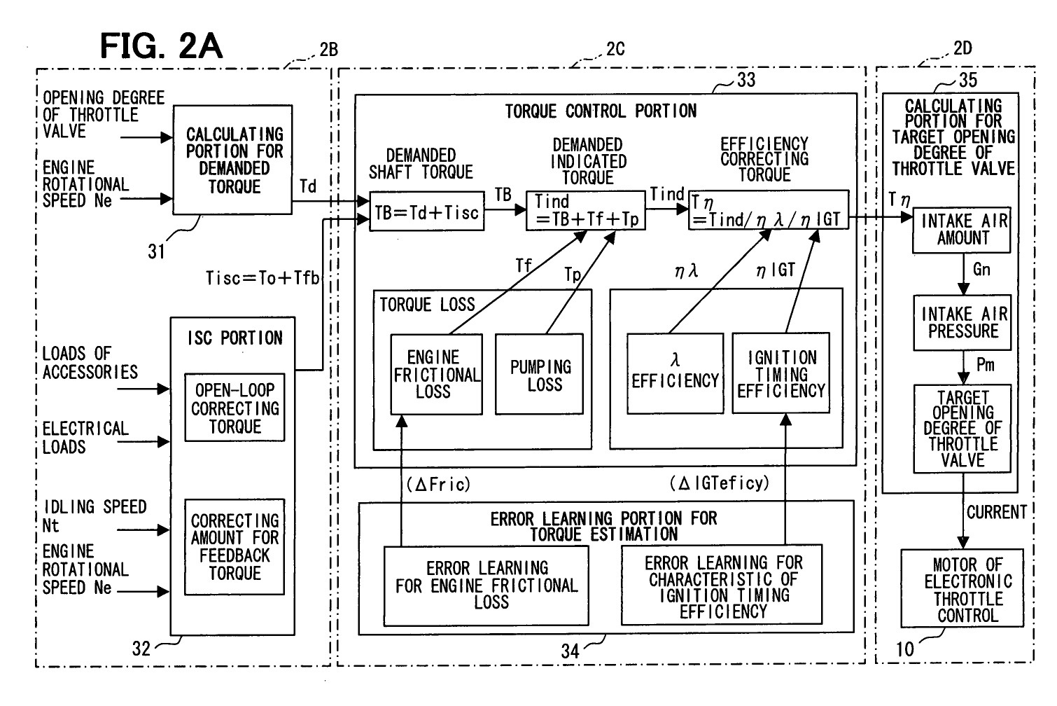

The ECU 27 repeatedly carries out, at a predetermined cycle, respective programs for the engine torque control during the engine operation, so that respective functions for the engine torque control shown in FIG. 2A are realized. The functions for the engine torque control will be explained.

A calculating portion 31 for a demanded torque calculates the engine torque (the demanded torque) “Td” demanded by the vehicle driver based on the opening degree of the acceleration pedal, the engine rotational speed “Ne”, and so on.

An ISC portion 32 has a function for calculating a correcting amount “Tfb” for feedback torque, in order to minimize the deviation (Nt−Ne) between a target idling rotational speed “Nt” and an actual engine rotational speed “Ne”. The ISC portion 32 has another function for calculating an open-loop correcting torque “To”, by adding a torque “Te” necessary for driving electrical loads to a torque “Tac” necessary for driving accessories, such as an air conditioning apparatus. Furthermore, the ISC portion 32 has a function for calculating an ISC correcting torque “Tisc”, by adding the correcting amount “Tfb” for feedback torque to the open-loop correcting torque “To”.

A torque control portion 33 calculates at first a demanded shaft torque “TB” by adding the ISC correcting torque “Tisc” to the the demanded torque “Td”, and then calculates a demanded indicated torque “Tind” by adding various loss torques to the demanded shaft torque “TB”. The loss torques include, for example, a loss torque “Tf” of engine friction (hereinafter also referred to as the engine friction loss torque “Tf”), a loss torque “Tp” of pumping (hereinafter also referred to as the pumping loss torque “Tp”), and so on. The engine friction loss torque “Tf” is calculated based on a map, in which the engine friction loss torque “Tf” is defined by parameters of oil temperature and the engine rotational speed. Data for the map for calculating the engine friction loss torque “Tf” are stored in a rewritable and non-volatile memory device (not shown), such as a backup RAM of the ECU 27, and such data are corrected by errors “ΔFric” of a characteristic for the engine frictional loss, which have been learned by an error learning portion 34 for the torque estimation during the engine operation. This will be explained more in detail later. The pumping loss torque “Tp” is likewise calculated based on a map, in which the pumping loss torque “Tp” is defined by parameters of the intake air pressure and the engine rotational speed.

The torque control portion 33 further calculates an efficiency correcting torque “Tη”, by dividing the demanded indicated torque “Tind” by a λ efficiency (an A/F ratio efficiency) “ηλ” and an ignition timing efficiency “ηIGT”. The A efficiency “ηλ” is a dimensionless parameter for evaluating an influence of an excess air factor “λ” to the indicated torque, and it is defined with respect to the excess air factor “λ”, wherein the λ efficiency “ηλ” is set as “1” when the excess air factor “λ” is “1”. In other words, the indicated torque is set to be “1” when the excess air factor “λ” is “1”, and the λ efficiency “ηλ” is an indicator for indicating the degree of the indicated torque relative to the excess air factor “λ”, with reference to the above point (the indicated torque=1, when “λ”=1).

The ignition timing efficiency “ηIGT” is a dimensionless parameter for evaluating an influence of a delayed amount of the ignition timing to the indicated torque, and it is defined with respect to the delayed amount of the ignition timing “IGT” from the most appropriate timing “MBT”. The ignition timing efficiency “ηIGT” is set as “1” when the delayed amount of the ignition timing from “MBT” is zero (i.e. when the ignition timing is at “MBT”), because the indicated torque becomes maximum when the delayed amount of the ignition timing from “MBT” is zero. In other words, the indicated torque is set to be “1” when the delayed amount of the ignition timing from “MBT” is zero, and the ignition timing efficiency “ηIGT” is an indicator for indicating the degree of the indicated torque relative to the delayed amount of the ignition timing from “MBT”, with reference to the above point (the indicated torque=1, when the ignition timing is at “MBT”).

Data for the map for calculating the ignition timing efficiency “ηIGT” are stored in a rewritable and non-volatile memory device (not shown), such as a backup RAM of the ECU 27, and such data are corrected by errors “ΔIGTeficy” of a characteristic for the ignition timing efficiency, which have been learned by the error learning portion 34 for the torque estimation during the engine operation. This will be explained more in detail later.

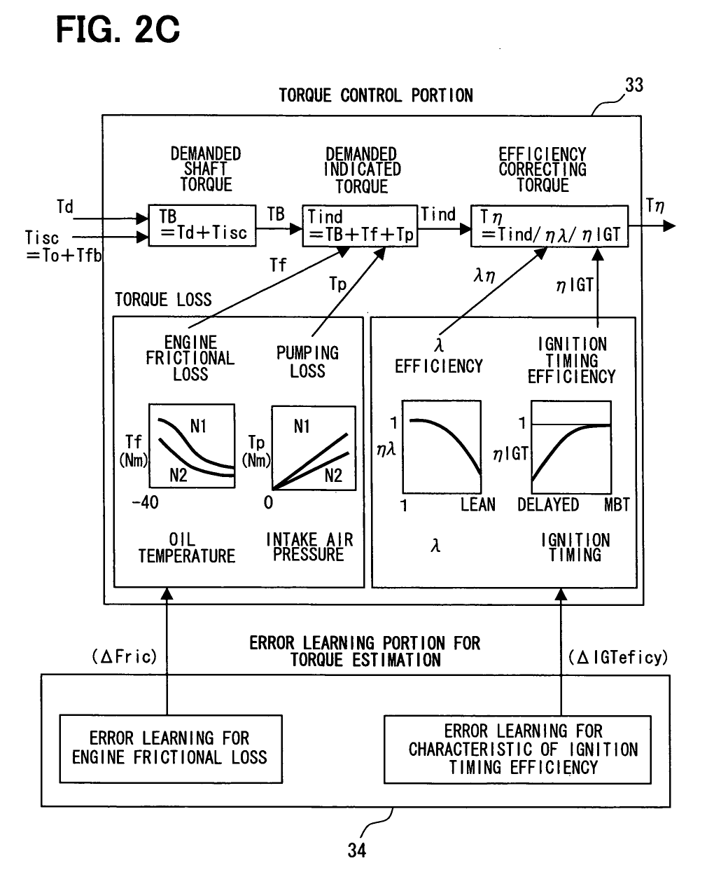

The error learning portion 34 for the torque estimation repeatedly carries out, at a predetermined cycle, a process (routine) shown in FIG. 4. The error learning portion 34 detects an error (i.e. a torque estimation error) between the estimated value and the actual value of the engine torque. The error learning portion 34 learns the errors “ΔFric” of the characteristic for the engine frictional loss, which is caused by the secular change, based on the torque estimation error detected when the ignition timing is around “MBT”. The error learning portion 34 further learns the errors “ΔIGTeficy” of the characteristic for the ignition timing efficiency, which is caused by the secular change for the characteristic indicating the relation between the engine torque change and the ignition timing, based on the torque estimation error detected when the ignition timing is delayed from the most appropriate timing “MBT”. The error learning portion 34 corrects the map data for the engine friction loss torque “Tf”, based on the errors “ΔFric” of the characteristic for the engine frictional loss. And the error learning portion 34 corrects the map data for the ignition timing efficiency “ηIGT”, based on the errors “ΔIGTeficy” of the characteristic for the ignition timing efficiency.

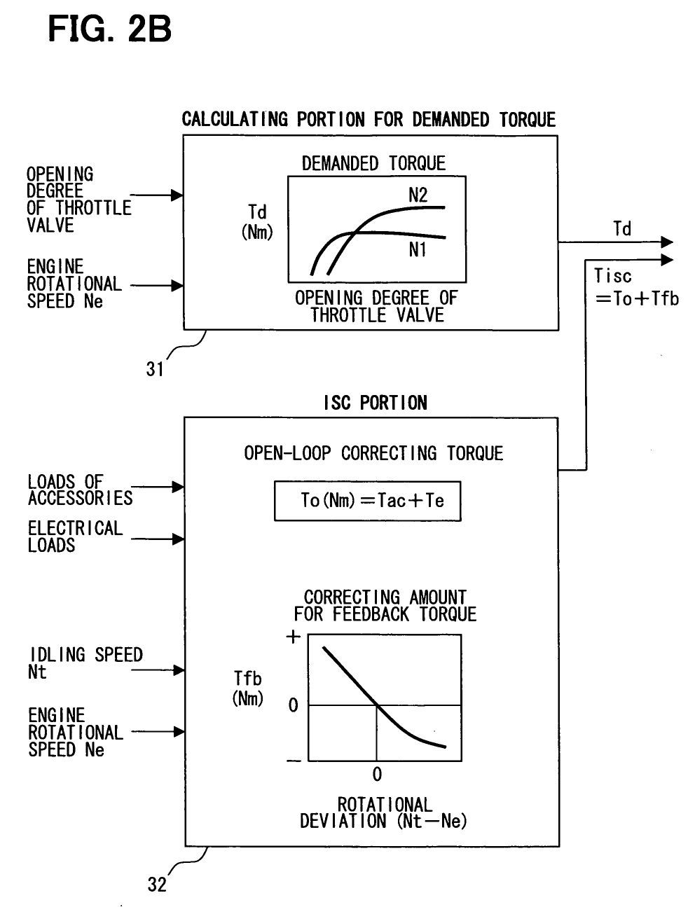

As shown in FIG. 3, the error (i.e. the torque estimation error) between the estimated value (the applied value) and the actual value of the engine torque includes the error “ΔFric” of the characteristic for the engine frictional loss and the error “ΔIGTeficy” of the characteristic for the ignition timing efficiency. The error “ΔFric” of the characteristic for the engine frictional loss does not largely change with respect to the change of the ignition timing. In other words, the error “ΔFric” is almost constant. On the other hand, the error “ΔIGTeficy” of the characteristic for the ignition timing efficiency becomes larger, as the delayed amount of the ignition timing from “MBT” becomes larger. The torque estimation error “ΔTrq” at “MBT” corresponds to the error “ΔFric” of the characteristic for the engine frictional loss, because the error “ΔIGTeficy” of the characteristic for the ignition timing efficiency becomes zero at “MBT”.

It is important to learn at first the error “ΔFric” of the characteristic for the engine frictional loss, because the error “ΔFric” does not largely change with respect to the change of the ignition timing (the error “ΔFric” is almost constant). Then, it becomes possible to learn with higher accuracy the error “ΔIGTeficy” of the characteristic for the ignition timing efficiency, by subtracting the learning value for the error “ΔFric” of the characteristic for the engine frictional loss from the torque estimation error “ΔTrq” detected when the ignition timing is delayed from “MBT”.

The torque estimation error “ΔTrq” as well as the error “ΔFric” of the characteristic for the engine frictional loss can be calculated as a value of the torque. The error “ΔIGTeficy” of the characteristic for the ignition timing efficiency is obtained by dividing the subtracted amount (the torque amount, which is calculated by subtracting the error “ΔFric” from the torque estimation error “ΔTrq”) by the engine torque at “MBT”, as in the following formula:

“ΔIGTeficy”=(“ΔTrq”−“ΔFric”)/the engine torque at “MBT”

In the above formula, the engine torque at “MBT” is obtained during the step for the application work, and stored in the memory device of the ECU 27. According to the above formula, a changing rate of the engine torque with reference to the engine torque at “MBT” can be learned as the error “ΔIGTeficy” of the characteristic for the ignition timing efficiency, when the ignition timing is delayed from “MBT”.

A calculating portion 35 for a target opening degree of the throttle valve calculates a demanded intake air amount “Gn” from a map, based on the engine rotational speed and the efficiency correcting torque Tη (a final demanded indicated torque, which is corrected by the λ efficiency “ηλ” and the ignition timing efficiency “ηIGT”) calculated by the torque control portion 33. Then, the calculating portion 35 calculates a demanded intake air pressure “Pm” from a map, based on the above demanded intake air amount “Gn” and the engine rotational speed. Further, the calculating portion 35 calculates a target opening degree “Th” of the throttle valve, based on the demanded intake air pressure “Pm”, the atmospheric pressure “Po”, the temperature “Ta” of the intake air, and so on.

The electric current to the electric motor 10 of the electronic throttle control system (i.e. the wireless throttle control system) is controlled in accordance with the above target opening degree “Th” of the throttle valve, so that actual opening degree of the throttle valve is adjusted to a position corresponding to the target opening degree “Th”.

A process for correcting the learning values for the torque estimation error will be explained with reference to FIG. 4. The process (routine) of FIG. 4 is carried out by the ECU 27 at a predetermined period during the engine operation.

When the process starts, the ECU 27 detects the current operational condition of the engine at a step 101, and determines at the next step 102 whether the engine is at its idling operation or an automatic transmission device is in its gear changing mode. When neither the engine is at its idling operation nor the automatic transmission device is in its gear changing mode, the ECU determines that a condition for correcting the learning values is not satisfied, so that the process is terminated without performing the following steps.

When the ECU determines that the engine is at its idling operation or the automatic transmission device is in its gear changing mode, the ECU determines that the condition for correcting the learning values is satisfied. Then, the learning values for the torque estimation error are corrected in the following manner. At first, the ECU detects a deviation “ΔNe” of the engine rotational speed at the engine idling operation or at the gear changing mode, at a step 103.

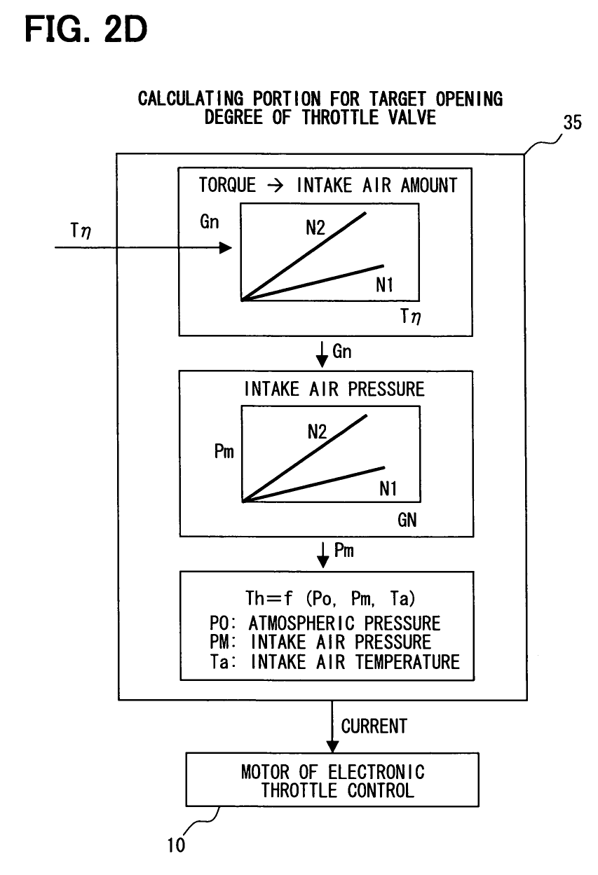

In the case that the engine is in its idling operation, the ECU detects the deviation “ΔNe” of the engine rotational speed between the actual engine rotational speed “N1” and the target idling rotational speed “N2”, as the information for the torque estimation error “ΔTrq”, as shown in FIG. 5. This is because the deviation “ΔNe” of the engine rotational speed between the actual engine rotational speed “N1” and the target idling rotational speed “N2” becomes larger as the torque estimation error “ΔTrq” becomes larger.

It is preferable to detect the deviation “ΔNe” of the engine rotational speed between the actual engine rotational speed “N1” and the target idling rotational speed “N2”, before an operation for ISC (Idle Speed Control) is carried out. Because, the intake air amount is controlled in a feedback manner, such that the deviation “ΔNe” of the engine rotational speed between the actual engine rotational speed “N1” and the target idling rotational speed “N2” will become smaller, after starting the operation for ISC.

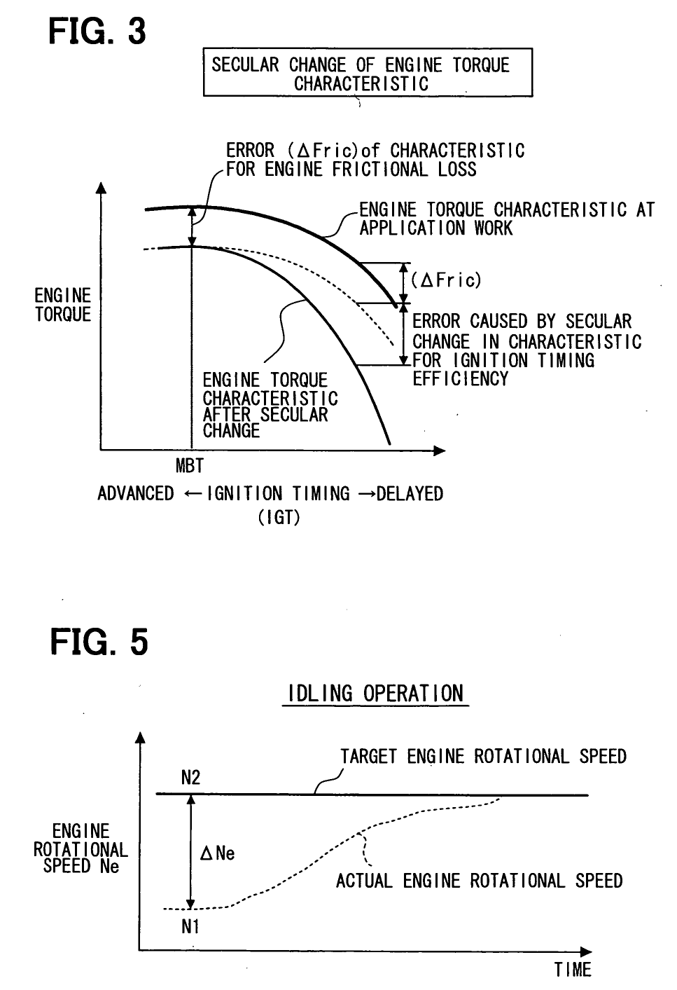

On the other hand, in the case that the automatic transmission is in its gear changing mode, the ECU detects the deviation “ΔNe” of the engine rotational speed between the actual engine rotational speed “N1” and an ideal idling rotational speed “N2” at such gear change operation, as the information for the torque estimation error “ΔTrq”, as shown in FIG. 6 (indicating an example in which the gear is shifted up). The ideal idling rotational speed “N2” at the gear change operation is already obtained in the process for the application work. Accordingly, the deviation “ΔNe” of the engine rotational speed between the actual engine rotational speed “N1” and the ideal idling rotational speed “N2” at the gear change operation can be obtained, as the information for the torque estimation error “ΔTrq”.

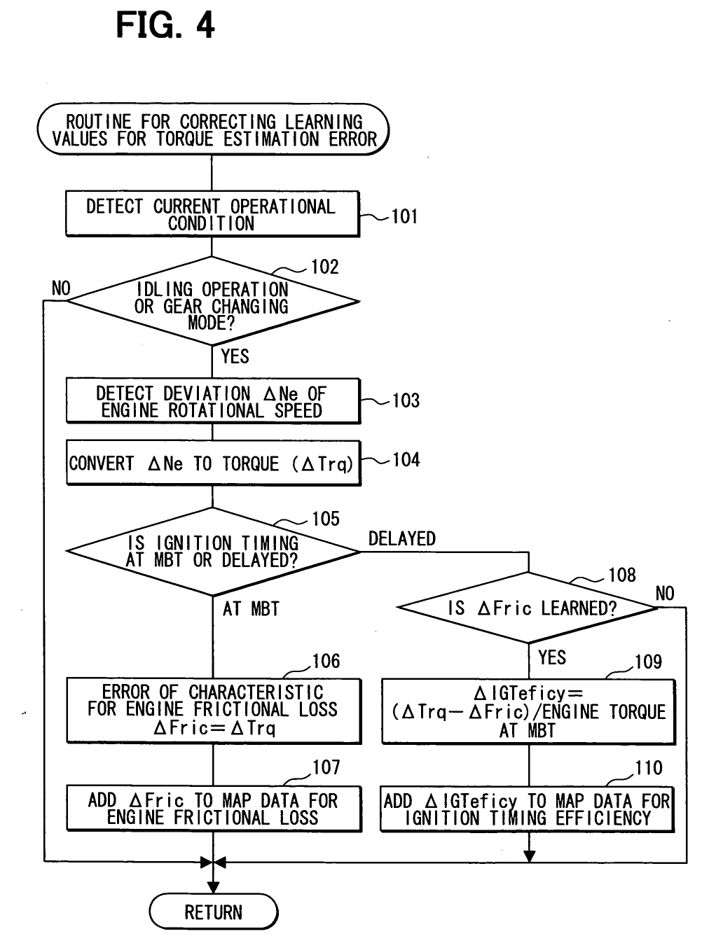

The process goes to a step 104, after the deviation “ΔNe” of the engine rotational speed at the engine idling operation or the gear changing mode is detected at the step 103, as above. At the step 104, the ECU calculates the torque estimation error “ΔTrq” from a map shown in FIG. 7, based on the deviation “ΔNe” (=N2−N1) of the engine rotational speed. The map for the torque estimation error “ΔTrq” shown in FIG. 7 has the same characteristic to that of the map in FIG. 2D, from which the demanded intake air amount “Gn” is calculated based on the engine rotational speed and the efficiency correcting torque “Tη”.

The process goes to a step 105, after the calculation of the torque estimation error “ΔTrq”. The ECU determines whether the current ignition timing is around the “MBT” or delayed, and the process moves to a step 106 when the ignition timing is around the “MBT”. At the step 106, the ECU 27 directly learns the torque estimation error “ΔTrq” of this process as the error “ΔFric” of the characteristic for the engine frictional loss. In this case, the error “ΔFric” of the characteristic for the engine frictional loss is obtained for the respective engine operating conditions, such as the engine rotational speed “Ne”, the oil temperature, and so on.

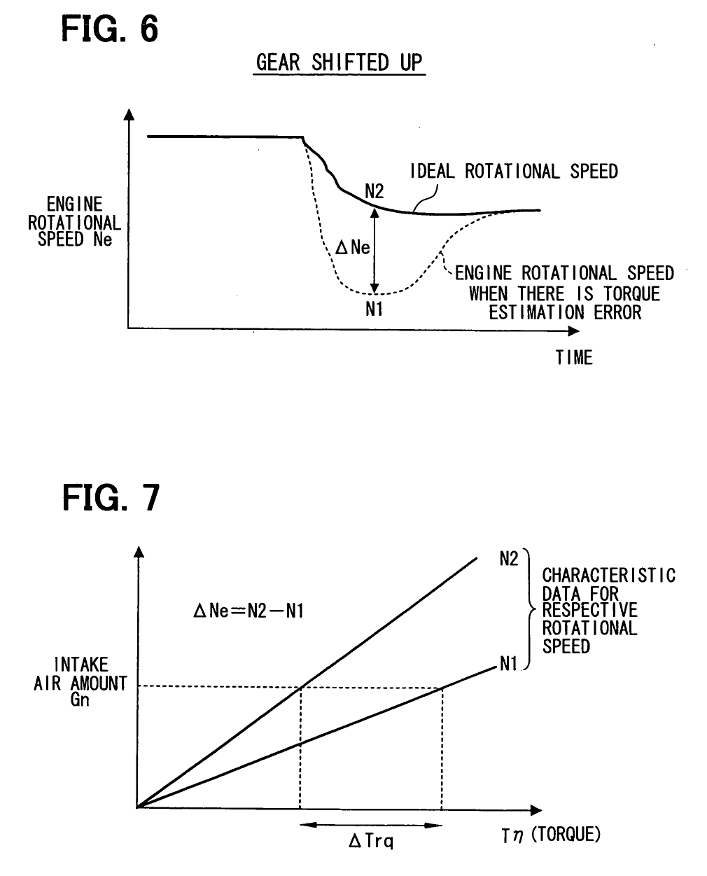

Then, the process goes to a step 107, at which the ECU updates the map data for the engine frictional loss, such that the error “ΔFric” (calculated in this time) of the characteristic for the engine frictional loss is added to the map date “Tf” (as shown in FIG. 8) memorized in the rewritable memory device of the ECU 27; namely

“Tf” after correction=“Tf” before correction+“66 Fric”

The map for the engine frictional loss is formed as a map having, as its parameters, the engine operational conditions such as the engine rotational speed “Ne”, the oil temperature, and so on. The map data are corrected by the error “ΔFric” (calculated in this time) of the characteristic for the engine frictional loss, so that the map data correspond to the engine operational condition of the learning values of this time. The engine friction loss torque “Tf” is calculated during the engine operation from the above map for the engine frictional loss, which is corrected by the above explained steps.

The process goes to a step 108, when the ECU determines at the step 105 that the ignition timing is delayed. At the step 108, the ECU determines whether the error “ΔFric” of the characteristic for the engine frictional loss is already calculated and learned. In the case that the error “ΔFric” is not yet calculated and learned, the process is terminated.

When the error “ΔFric” is calculated and learned, the process goes to a step 109, at which the ECU calculates the error “ΔIGTeficy” of the characteristic for the ignition timing efficiency in such a manner that the subtracted amount (the torque amount, which is calculated by subtracting the error “ΔFric” from the torque estimation error “ΔTrq”) is divided by the engine torque at “MBT”. Namely:

“ΔIGTeficy”=(“ΔTrq”−“ΔFric”)/the engine torque at “MBT”

The engine torque at “MBT” is obtained during the step for the application work, and stored in the memory device of the ECU 27. Accordingly, the changing rate of the engine torque with reference to the engine torque at “MBT” can be learned as the error “ΔIGTeficy” of the characteristic for the ignition timing efficiency, when the ignition timing is delayed from “MBT”.

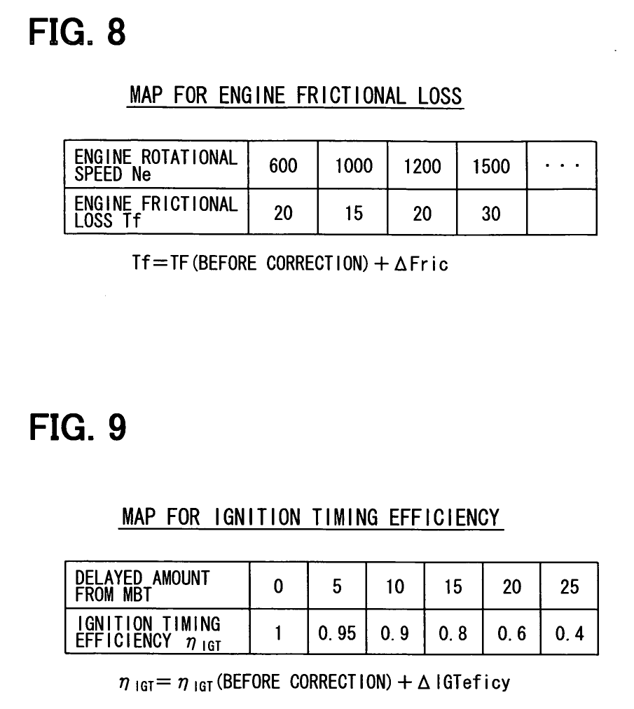

Then, the process goes to a step 110, at which the ECU updates the map data for the ignition timing efficiency “ηIGT” (as shown in FIG. 9), such that the map data for the ignition timing efficiency “ηIGT” corresponding to the delayed amount of this time is read out from the rewritable memory device of the ECU 27, and the error “ΔIGTeficy” (calculated in this time) of the characteristic for the ignition timing efficiency is added to the above ignition timing efficiency “ηIGT”. Namely;

“ηIGT” after correction=“ΔIGT” before correction+“ΔIGTeficy”

As above, the ignition timing efficiency “ηIGT” is calculated during the engine operation from the above map for the ignition timing efficiency, which is corrected by the above explained steps.

According to the above process (routine), the deviation “ΔNe” of the engine rotational speed is detected at the engine idling operation and at the gear changing mode, so as to calculate the torque estimation error “ΔTrq”. However, the torque estimation error “ΔTrq” may be calculated by detecting the deviation “ΔNe” of the engine rotational speed either at the engine idling operation or at the gear changing mode. Furthermore, the torque estimation error “ΔTrq” may be calculated by detecting the deviation “ΔNe” of the engine rotational speed (between the target value and the actual value) at any other operational conditions of the engine.

According to the above embodiment, the error “ΔIGTeficy” of the characteristic for the ignition timing efficiency (which is caused by and in accordance with the delayed amount of the ignition timing) can be also learned in addition to the error “ΔFric” of the characteristic for the engine frictional loss, as the torque estimation error which is caused by the secular change of the engine torque characteristic. Accordingly, the torque estimation error (which is caused by the secular change of the engine torque characteristic) can be learned more accurately than the conventional method. Namely, the accuracy for correcting the learning values of the engine torque with respect to the secular change of the engine torque characteristic can be improved.

Furthermore, according to the above embodiment, the changing rate of the engine torque (in the case that the ignition timing is delayed from “MBT”) relative to the engine torque (in the case that the ignition timing is at “MBT”) is learned as the error “ΔIGTeficy” of the characteristic for the ignition timing efficiency. Accordingly, the error “ΔIGTeficy” of the characteristic for the ignition timing efficiency can be learned in the same measuring unit to the map data for the ignition timing efficiency “ηIGT”, which is generally used when correcting the demanded indicated torque in accordance with the delayed amount of the ignition timing. As a result, the process for correcting the map data for the ignition timing efficiency can be carried out with a simpler calculation process (i.e. addition or subtraction) by using the learning values for the error “ΔIGTeficy” of the characteristic for the ignition timing efficiency.

The present invention is not limited to the embodiment explained above. The present invention can be modified in various ways, without departing from the spirit of the invention. For example, the present invention can be also applied to such an engine, in which the fuel is directly injected into the cylinders, without being limited to the engine, in which the fuel is injected in the intake manifold (so-called an intake port fuel injection).

What is claimed is:

1. An engine torque estimating device for estimating an engine torque comprising:
a first means for detecting a torque estimation error, which is an error between an estimated value and an actual value of the engine torque;
a second means for learning an error of a characteristic for engine frictional loss, based on the torque estimation error which is detected when ignition timing is around a most appropriate timing;
a third means for learning an error of a characteristic, which represents a relation between the ignition timing and an engine torque change, based on the torque estimation error which is detected when ignition timing is delayed from the most appropriate timing, wherein the error corresponds to an error of a characteristic for ignition timing efficiency; and
a fourth means for correcting the estimated value of the engine torque based on learning values obtained in the third means.

2. An engine torque estimating device according to claim 1, wherein
the first means detects a deviation of engine rotational speed between an actual engine rotational speed and a target idling rotational speed during an idling operation of the engine, and calculates the torque estimation error based on the deviation.

3. An engine torque estimating device according to claim 1, wherein
the first means detects a deviation of engine rotational speed between an actual engine rotational speed and an ideal idling rotational speed during a gear change operation, and calculates the torque estimation error based on the deviation.

4. An engine torque estimating device according to claim 1, wherein
the third means learns the error of the characteristic for the ignition timing efficiency, based on the torque estimation error which is detected when the ignition timing is delayed from the most appropriate timing as well as a learning value for the error of the characteristic for the engine frictional loss, after the second means has learned the error of the characteristic for the engine frictional loss.

5. An engine torque estimating device according to claim 1, wherein
the third means learns a changing rate of the engine torque as the error of the characteristic for the ignition timing efficiency,
wherein the changing rate of the engine torque is calculated from the engine torque when the ignition timing is around the most appropriate timing and the engine torque when the ignition timing is delayed from the most appropriate timing.

6. A method for estimating an engine torque comprising:
a first step for detecting a torque estimation error, which is an error between an estimated value and an actual value of the engine torque;
a second step for learning an error of a characteristic for engine frictional loss, based on the torque estimation error which is detected when ignition timing is around a most appropriate timing;
a third step for learning an error of a characteristic, which represents a relation between the ignition timing and an engine torque change, based on the torque estimation error which is detected when ignition timing is delayed from the most appropriate timing, wherein the error corresponds to an error of a characteristic for ignition timing efficiency; and
a fourth step for correcting the estimated value of the engine torque based on learning values obtained in the third means.

7. A method for estimating an engine torque according to claim 7, wherein
at the first step, a deviation of engine rotational speed between an actual engine rotational speed and a target idling rotational speed is detected during an idling operation of the engine, and
the torque estimation error is calculated based on the deviation.

8. A method for estimating an engine torque according to claim 1, wherein
at the first step, a deviation of engine rotational speed between an actual engine rotational speed and an ideal idling rotational speed is detected during a gear change operation, and
the torque estimation error is calculated based on the deviation.

9. An engine torque estimating device according to claim 1, wherein
at the third step, the error of the characteristic for the ignition timing efficiency is learned, based on the torque estimation error which is detected when the ignition timing is delayed from the most appropriate timing as well as a learning value for the error of the characteristic for the engine frictional loss, after the error of the characteristic for the engine frictional loss has been learned at the second step.

10. An engine torque estimating device according to claim 1, wherein
at the third step, a changing rate of the engine torque is learned as the error of the characteristic for the ignition timing efficiency,
wherein the changing rate of the engine torque is calculated from the engine torque when the ignition timing is around the most appropriate timing (MBT) and the engine torque when the ignition timing is delayed from the most appropriate timing.
